(19) United States
(12) Patent Application Publication
(10) Pub. No.: US 2006/0257101 A1
(43) Pub. Date: Nov. 16, 2006

(54) Broadcast receiver and broadcast receiving method

(76) Inventor: Takahiro Kimura, Fukaya-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/402,982

(22) Filed: Apr. 13, 2006

(30) Foreign Application Priority Data
Apr. 14, 2005 (JP) 2005-117284

(51) Int. Cl. H04N 5/91

(52) U.S. Cl. 386/83

(57) ABSTRACT

Permanent recording continuation is prevented and a recorded content is guaranteed to be surely recorded by prescribe amount (for prescribed time). For that purpose, a temporary storing area is secured in advance on a recording medium by prescribed amount. When a temporary storing operation caused by temporary interruption is conducted, sequential recording is performed from the top of the temporary storing area and when the area is filled with the recorded content, overwrite-recording is performed from the top of the area. A recording stopping time then set to a prescribed time point from a recording start.

### CROSS-REFERENCE TO RELATED APPLICATIONS

This application is based upon and claims the benefit of priority from Japanese Patent Application No. 2005-117284, filed Apr. 14, 2005, the entire contents of which are incorporated herein by reference.

### BACKGROUND

1. Field

Embodiments of the present invention relate to a broadcast receiver and a broadcast receiving method. More specifically, one embodiment of the present invention relates to improvement in a recording function.

2. Description of the Related Art

In recent years, an information recording medium such as a hard disk and an optical disk as a recording medium has had its storage capacity increased. Therefore, a method and an apparatus for automatically recording a desired program on a recording medium by connecting a recording/reproducing device using such an information recording medium to, for example, a television receiver have been available.

In general, program recording reservation information is prepared by using electronic program guide (EPG) information so as to realize an automatic recording function and an automatic recording/reproducing apparatus. It has been taken into consideration for a device to automatically set the recording reservation information by automatically retrieving a program which seems to be relevant to a concerned category depending on the EPG information when a user specified a desired category.

The automatic recording/reproducing apparatus has a temporary storing function to record a program so as to view it later if the user presses a recording button when the user has to get away from the place where the apparatus is placed during viewing of the program (refer to, for example, patent document of Japanese Patent Application Publication (KOKAI) No. 2002-191005).

The temporary storing function starts an operation with conducting a recording operation when the user interrupts the viewing to get away from the place. However, unless the user releases the recording operation, there is a possibility that the temporary storing function continues its operation permanently and there is a problem that a storage device is shortened in its service life. There has been a conventionally conceived method, wherein the method acquires a termination time of the program with the temporary storing operation conducted therefore from an electronic program table and automatically stops the recording operation once the termination time has come.

However, according to this method, some interruption timing (timing to start temporary storing or recording operation) causes a problem sometimes. It is assumed that, for example, the viewer wants to watch a program B. And programs A and B are assumed to be broadcasted sequentially in the order. Furthermore, it is assumed that the viewer stands by while the program A is on the air. In this case, if the temporary storing or recording operation is required before the program A comes to end, the viewer cannot record the next program B sometimes. This is because the automatic recording/reproducing apparatus acquires the termination time of the program A from the electronic program table and automatically stops recording once the termination time has come.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary view for schematically explaining a digital television broadcast receiver with the present invention adopted thereto;

FIG. 2 is an exemplary view showing an external view of the broadcast receiver in FIG. 1;

FIG. 3 is an exemplary view for further specifically showing a configuration of an inside of the broadcast receiver in FIG. 1;

FIG. 4 is an exemplary view for schematically explaining a remote controller used in the broadcast receiver of the present invention;

FIG. 5 is an exemplary flowchart when the broadcast receiver in FIG. 1 records a program on the basis of EPG information;

FIG. 6 is an exemplary view showing an example when the broadcast receiver in FIG. 1 displays program information on a video display unit;

FIG. 7 is an exemplary view showing an example of a screen when a slight-time recording function unit is operated in the broadcast receiver of the present invention;

FIG. 8 is an exemplary view showing an example of a screen in an initial stage when the slight-time recording function unit is operated in the broadcast receiver of the present invention;

FIG. 9 is an exemplary view showing an example of a screen before a revolving (or chasing) reproduction function becomes available when the slight-time recording function unit is operated and after recording is started in the broadcast receiver of the present invention;

FIG. 10 is an exemplary view showing an example of a screen when the revolving reproduction function becomes possible, when the slight-time recording function unit is operated and after the recording is started in the broadcast receiver of the present invention;

FIG. 11 is an exemplary view showing an example of a screen during recording when the slight-time recording function unit is operated and the revolving reproduction becomes available in the broadcast receiver of the present invention;

FIG. 12 is an exemplary view showing an example of an initial screen when a user returns back to a place where the broadcast receiver is placed to conduct a reproducing operation and shifts the broadcast receiver to preparation of the revolving reproduction;

FIG. 13 is an exemplary view showing an aspect of a change of a color image to a monochrome image when the user shifts the broadcast receiver to the preparation of the revolving reproduction;

FIG. 14 is an exemplary view showing an aspect in which the state in FIG. 13 has further progressed and a screen has become completely dark;

FIG. 15 is an exemplary view showing an aspect in which a video recorded with slight-time recording is brought into a revolving reproduction state;

FIG. 16 is an exemplary view showing an example of displaying an operation panel on a screen during the revolving reproduction;

FIG. 17 is an exemplary view showing an example of the screen during the revolving reproduction of a temporarily stored and recorded content;

FIG. 18 is an exemplary view showing an example of another screen during the revolving reproduction of the temporarily stored and recorded content;

FIG. 19 is an exemplary view showing a further other screen during the revolving reproduction of the video recorded with slight-time recording;

FIG. 20 is an exemplary view showing an example of a screen used in the case that the user wants to confirm a screen of a channel different from a broadcast and a channel being on the air to be now in slight-time recording, immediately after starting the slight-time recording;

FIG. 21 is an exemplary block diagram extracting and showing featured parts of the present invention;

FIG. 22 is an exemplary flowchart for explaining operations of the featured parts of the present invention; and

FIG. 23 is an exemplary flowchart for explaining an operation of a countermeasure processor 56c when the power of the broadcast receiver of the present invention is shut off.

### DETAILED DESCRIPTION

Hereinafter, embodiments of the present invention will be explained by referring to the drawings. At first, we will schematically explain a broadcast receiver with the present invention adopted thereto.

One embodiment of the present invention provides a broadcast receiver and a broadcast receiving method capable of preventing a permanent recording continuation and surely guaranteeing recording of a recording content by a prescribed amount (for a prescribed time). The embodiment of the invention has recording means for recording the display signals one after another on the recoding medium when a temporary storing operation is input, and means for automatically stopping the temporary storing operation when a prescribed time period has elapsed from a recording start by the temporary storing operation.

Therefore, the embodiment of the present invention can prevent the permanent recording continuation and also surely guarantee recording of the recording content by the prescribed capacity (for the prescribed time).

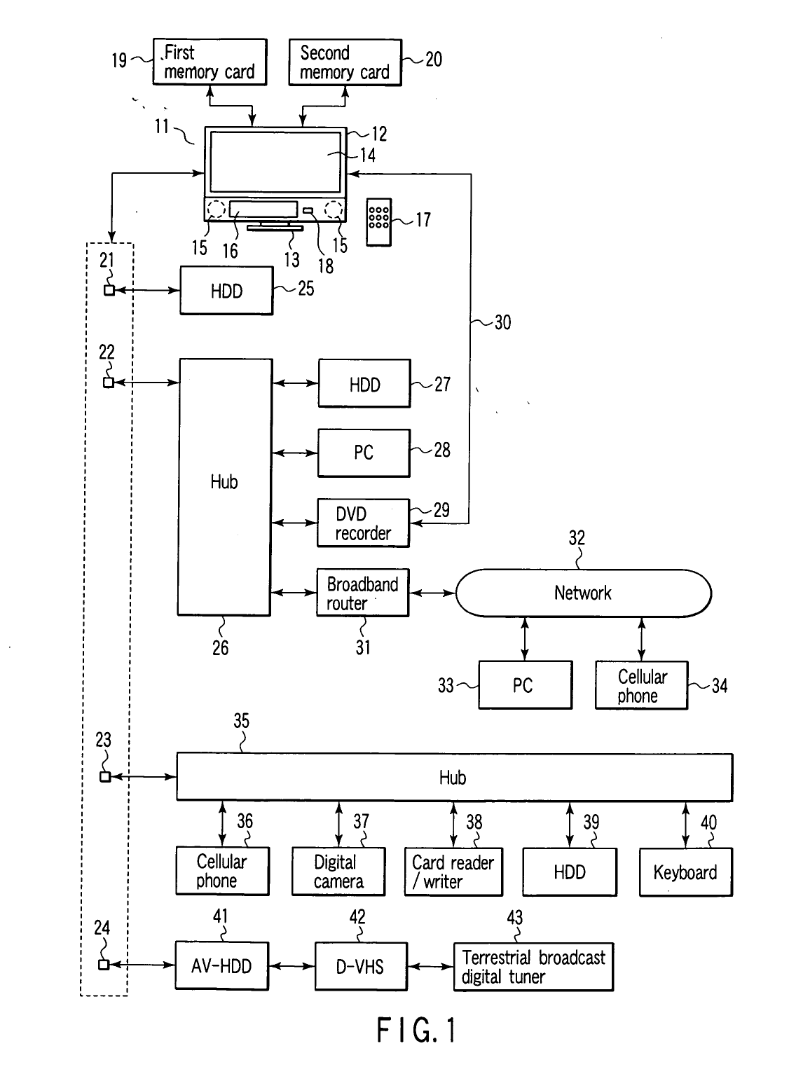

FIG. 1 schematically shows an external appearance of a digital television broadcast receiver 11 to be explained in each embodiment and an example of a network system configured around the broadcast receiver 11.

The broadcast receiver 11 is composed mainly of a thin cabinet 12 and a support base 13 making the cabinet 12 raised and supported. The cabinet 12 is provided with such as a flat panel type video display unit 14 composed of a liquid crystal display panel or the like, a loudspeaker 15, an operation unit 16, and a light receiving unit 18 to receive operation information transmitted from a remote controller 17.

The broadcast receiver 11 is adapted to receive a first detachable memory card 19 such as a Secure Digital (SD) memory card, a Multimedia Card (MMC) or a Memory Stick, and performs recording/reproducing of information about such as a program or a photograph to and from the first memory card 19.

The broadcast receiver 11 is further adapted to receive a second detachable memory card (IC card) 20 with, for example, contract information recorded thereon and performs recording/reproducing of information to and from the second memory card 20.

The broadcast receiver 11 is provided with a first local area network (LAN) terminal 21, a second LAN terminal 22, a universal serial bus (USB) terminal 23 and an i.Link terminal 24.

Among these parts, the first LAN terminal 21 is used as a LAN-compatible HDD dedicated port. The first LAN terminal 21 is connected to a LAN-compatible HDD 25 being a network attached storage (NAS). The first LAN terminal 21 is used to record/reproduce information to and from through a network (e.g., Ethernet network).

As mentioned above, by providing the first LAN terminal 21 to be the LAN-compatible HDD dedicated port, the broadcast receiver 11 can stably record a program with a high image quality to the HDD 25 without being influenced by other network environment or the status of use of the network.

The second LAN terminal 22 is used as a general LAN-compatible port using Ethernet. The second LAN terminal 22 is connected to equipment, for example, a LAN-compatible HDD port 27, a personal computer (PC) 28, and a digital versatile disk (DVD) recorder 29 with a built-in HDD through a hub 26 and used to communicate information between the equipment and the broadcast receiver 11.

Since digital information communicated through the second LAN terminal 22 is control information, the DVD recorder 29 utilizes a dedicated analog transmission path 30 to transmit analog information of video and sound to the broadcast receiver 11.

The second LAN terminal 22 is connected to, for example, a network 32 such as the Internet via a broadband router 31 connected to the hub 26 and used to communicate information between a PC 33, a cellular phone 34 or the like, and the broadcast receiver 11 via the network 32.

The USB terminal 23 is used as a general USB-compatible port, connected to, for example, a cellular phone 36, a digital camera 37, a card reader/writer 38 for a memory card, an HDD 39 or a keyboard 40. The USB terminal is used to make information transmissions between the equipment and the broadcast receiver 11.

The foregoing i.Link terminal 24 serially connects an AV-HDD 41, a digital (D)-video home system (VHS) 42, etc. and supports information transmissions between the equipment and the broadcast receiver 11.

Here, the AV-HDD 41 connected to the i.Link terminal 24 is shown outside the broadcast receiver 11 in FIG. 1; however, it is actually incorporated in the support base 13. That is, the AV-HDD 41 is integrated with the broadcast receiver 11.

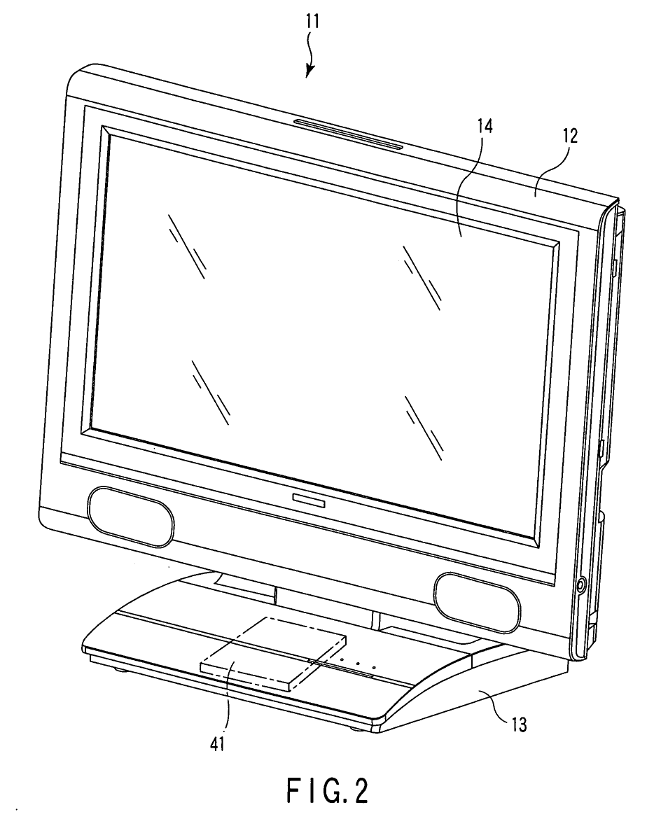

FIG. 2 shows the external appearance of the foregoing broadcast receiver 11. The AV-HDD 41 is incorporated in the support bas 13.

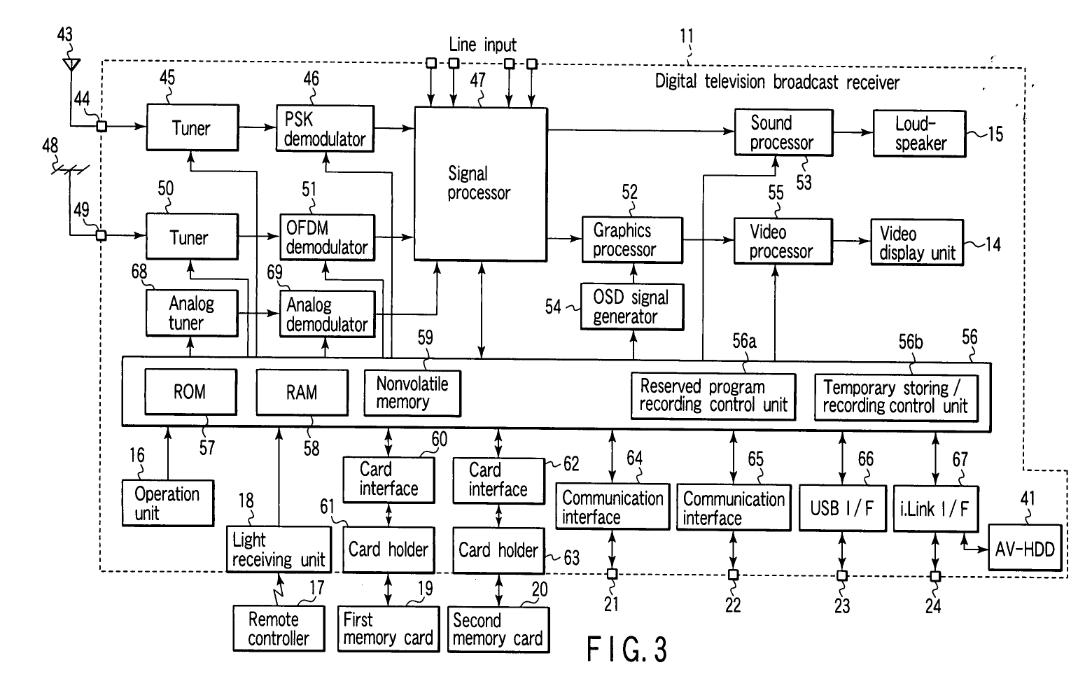

FIG. 3 shows the principle signal processing series of the foregoing broadcast receiver 11. That is, a satellite digital television broadcast signal, received at a first antenna 43 for receiving DBS digital broadcasts, is supplied to a tuner 45 for satellite digital broadcast through an input terminal 44, and the tuner 45 tunes a broadcast signal of a desired channel.

The broadcast signal tuned by the tuner 45 is supplied to a phase shift keying (PSK) demodulator 46 to be demodulated to a digital video signal and a digital sound signal, which are output to a signal processor 47.

And the broadcast receiver 11 also has an analog tuner 68 for receiving a terrestrial analog signal. An analog demodulator 69 demodulates the signal received by the analog tuner 68 to output it to the signal processor 47.

A terrestrial digital television broadcast signal, received at a second antenna 48 for receiving terrestrial digital broadcast, is supplied to a tuner 50 for the terrestrial digital television broadcast via an input terminal 49. The tuner 50 tunes the broadcast signal of the desired channel.

The broadcast signal tuned by the tuner 50 is supplied to an orthogonal frequency division multiplexing (OFDM) demodulator 51 to be demodulated to a digital video signal and a digital sound signal then are supplied to the signal processor 47.

The signal processor 47 selectively conducts prescribed digital signal processing to the digital video signals and sound signals supplied from the PSK demodulator 46 and further from the OFDM demodulator 51. The signal processor 47 processes the video signals and sound signals supplied from the analog demodulator 69 and further from the line input terminals, and outputs an output signal to a graphics processor 52 and a sound processor 53.

Among the processors, the graphics processor 52 has a function to superimpose an on-screen display (OSD) signal generated from an OSD signal generator 54 on the digital video signal supplied from the signal processor 47 and to output the superimposed signal. The graphics processor 52 can selectively output the video signal output from the signal processor 47 and the OSD signal output from the OSD signal generator 54 and also combine to output both outputs so that both outputs configures a half of a screen, respectively.

The digital video signal output from the graphics processor 52 is supplied to a video processor 55. The video processor 55 converts the input digital video signal into an analog video signal in a format possible to be displayed on the video display unit 14 and outputs the analog video signal to the video display unit 14 to produce a video display.

The sound processor 53 converts the input digital sound signal into an analog sound signal in a format that can be reproduced by the loudspeaker 15 and outputs the analog sound signal to the loudspeaker 15 to make a sound reproduction.

As further shown in FIG. 2, the broadcast receiver 11 further comprises a control unit 56 to integrally control the whole operations including the foregoing various receiving operations. The control unit 56 has a built-in central processing unit (CPU), which receives operation information from the operation unit 16, or receives operation information transmitted from the remote controller 17 and respectively controls each part so as to reflect operation contents thereto.

In this case, the control unit 56 mainly uses a read only memory (ROM) 57 with a control program to be executed by the CPU stored thereon, a random access memory (RAM) 58 to provide an operation area to the CPU and a nonvolatile memory 59 to which a variety of items of setting information and control information are stored.

The control unit 56 is connected to a card holder 61 to which the first memory card 19 can be attached through a card interface 60. The control unit 56 is adapted to support the exchange of information transmissions with the first memory card 19 attached to the card holder 61 through the card interface 60.

The control unit 56 is further connected to a card holder 63 to which the second memory card 20 can be attached through a card interface 62. The control unit 56 thereby can communicate information with the second memory card 20 attached to the card holder 63 through the card interface 62.

The control unit 56 is also connected to the first LAN terminal 21 through a communication interface 64. The control unit 56 thereby can communicate with the LAN-compatible HDD 25 connected to the first LAN terminal 21 through the communication interface 64. In this case, the control unit 56 has a dynamic host configuration protocol (DHCP) server function and assigns an Internet protocol (IP) address to the LAN-compatible HDD 25 connected to the first LAN terminal 21 to control the HDD 25.

The control unit 56 is further connected to the second LAN terminal 22 through a communication interface 65. The control unit 56 thereby can communicate with any equipment (refer to FIG. 1) connected to the second LAN terminal 22 through the communication interface 65.

The control unit 56 is further connected to the USB terminal 23 through a USB interface 66. The control unit 56 thereby can communicate with any equipment (refer to FIG. 1) connected to the USB terminal 23 through the USB interface 66.

Furthermore, the control unit 56 is connected to the i.Link (registered trademark) terminal 24 through an i.Link interface 67. Thereby, the control unit 56 can communicate with any equipment (refer to FIG. 1) connected to the i.Link terminal 24 through the i.Link interface 67.

The control unit 56 further includes a reserved program recording control unit 56a to reserve a recording program in advance to record it on a recording medium and a “slight-time recording function” executed by a temporary storing control unit 56b (may be referred to as loop recording control unit) as mentioned blow. Both reserved program recording control unit 56a and temporary storing control unit 56b refer to a timer, respectively. We will further describe in detail about these further included units later.

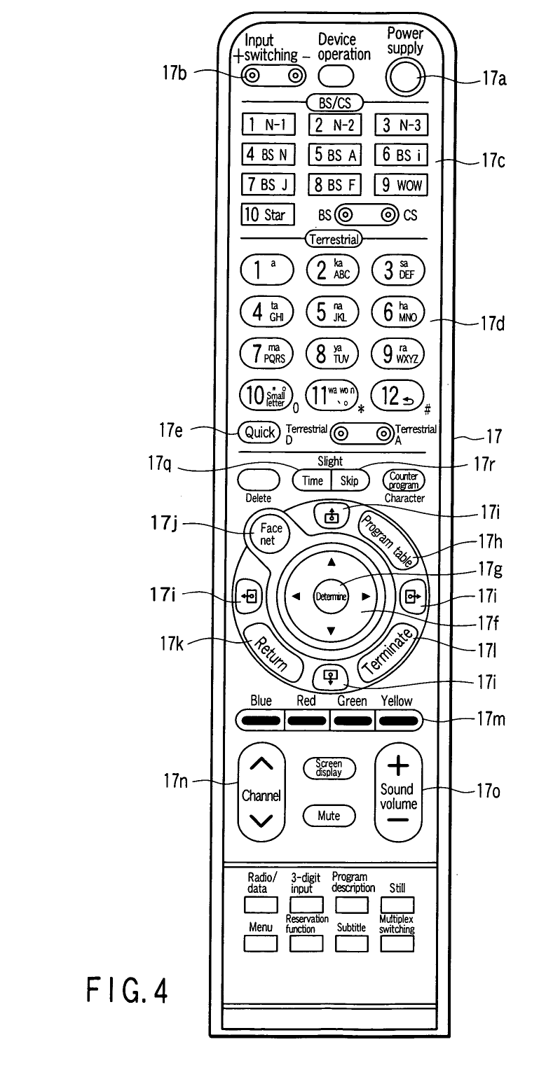

FIG. 4 shows the external appearance of the remote controller 17. The remote controller 17 mainly comprises a power key 17a, input switching keys 17b, direct tuning keys 17c for satellite digital broadcast channels, direct tuning keys 17d for terrestrial broadcast channels, a quick key 17e, a cursor key 17f, a determination key 17g, a program table key 17h, page switching keys 17i, a face net (registered trademark) (navigation) key 17j, a return key 17k, a terminate key 17l, color keys in blue, red, green and yellow 17m, a channel up and down key 17n, a sound volume adjusting key 17o, etc. Furthermore, the remote controller 17 has a “slight-time” key 17q and a “slight-skip” key 17r. We will describe how to use these two keys 17q and 17r later.

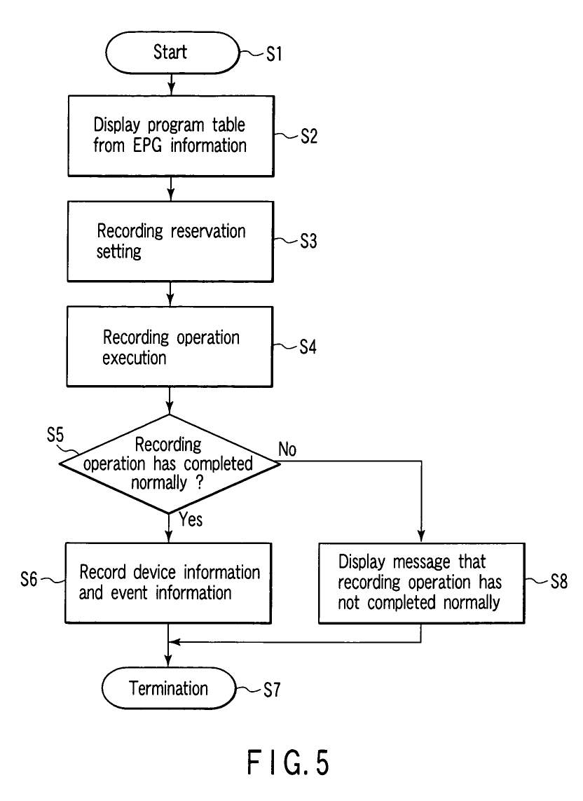

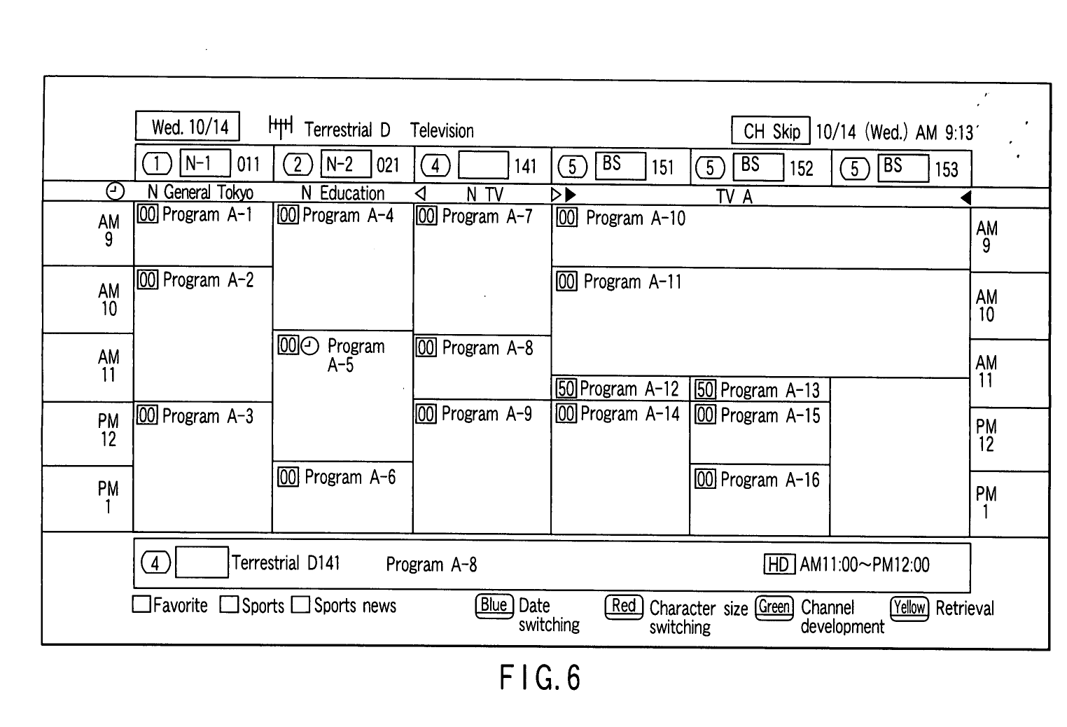

FIG. 5 shows the flowchart for explaining the operations of the broadcast receiver 11 in recording program into the digital recording equipment among each of the equipment connected to the terminals 21-24 of the broadcast receiver 11. That is, when processing is started resulting form a request of the recording of the program (step S1), the control unit 56 in FIG. 3 displays the program table as shown in FIG. 6 on the video display unit 14, based on the electronic program guide (EPG) information acquired from the broadcast signal (step S2).

The user then makes recording reservation setting of the desired programs on the basis of the displayed program table (step S3). In this setting, the broadcast receiver 11 selects the programs to be recorded from the program table and also selects to set the digital recording equipment to which the reservation-set program is recorded.

The control unit 56 executes a recording operation so as to record the reservation-set program into the reservation-set digital recording equipment when it has reached the preset time set for the recording reservation (step S4).

The control unit 56 then determines whether or not the program recording operation has normally completed (step S5), and if it is determined that the recording operation has completed normally (YES, in step S5), the broadcast receiver 11 records equipment information (equipment ID, equipment name, shared holder name, etc.) to specify the digital recording equipment which has performed recording. The broadcast receiver 11 further records event information (event ID, channel number, title, content description, category, recording range, image quality mode, etc.) related to the recorded program into the nonvolatile memory 59 (step S6) and terminates the processing described herein (step S7).

If it is determined that the operation has not completed normally (NO, in step S5), the control unit 56 in FIG. 3 displays a message indicating the fact that the operation has not completed normally onto the video display unit 14 in FIG. 1 (step S8) and terminates the processing (step S7).

According to the above-mentioned recording operations, the user can arbitrarily select multiple sets of digital recording equipment connected to each terminal 21-24 of the broadcast receiver 11 and record programs sequentially.

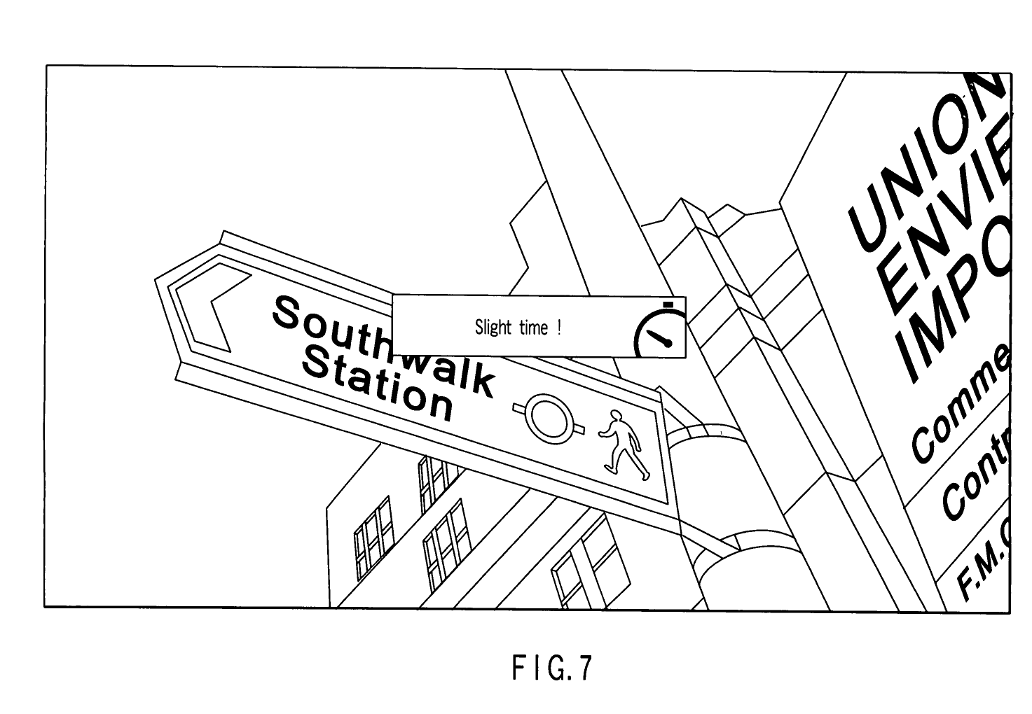

FIG. 7 to FIG. 20 show examples aspects in which the screens to explain the featured parts of the broadcast receiver 11 go on changing. This broadcast receiver 11 has the slight-time recording function, and when fulfilling this function, the broadcast receiver 11 utilize a recording medium such as the HDD 25 and secures a prescribed use capacity or a capacity of a fixed recording time (for example, six hours).

FIG. 7 shows an example of a screen which is appeared when a user presses the slight-time key 17q of the remote controller 17 for the purpose of getting away from the place where the broadcast receiver 11 is placed. The screen maintains a motion image going on the air and displays (for about 6 seconds) a comment of “Slight-time” (refer to center of screen).

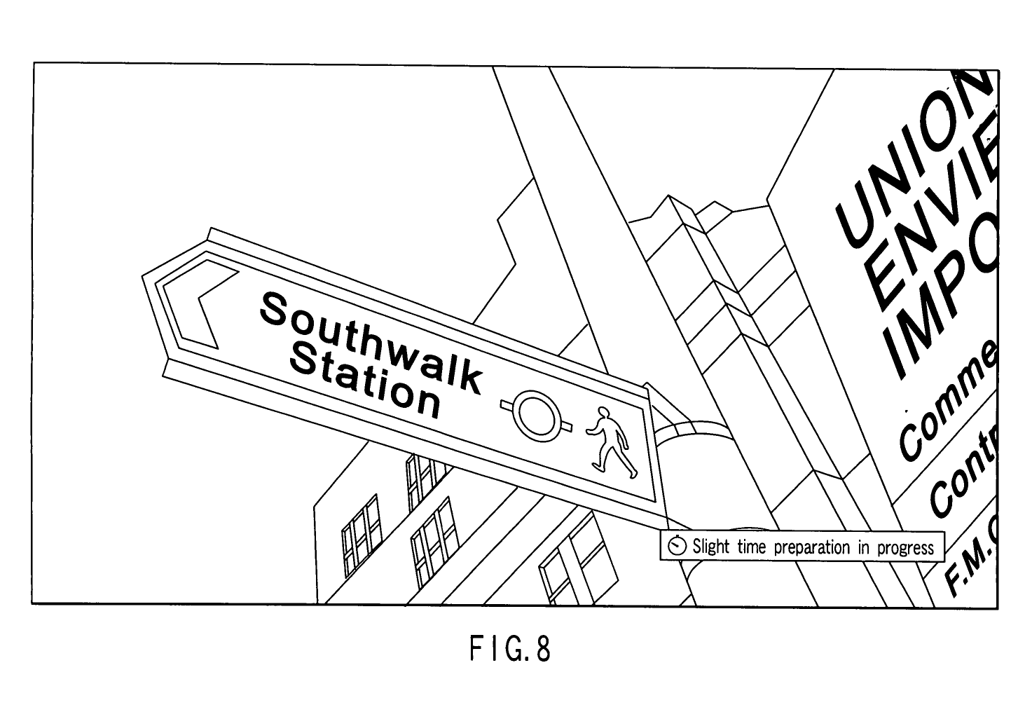

Next, the screen shifts to a state shown in FIG. 8. The screen in FIG. 8 displays a state with the motion image being on the air maintained thereon and displays a comment of “Slight-time is getting ready” (refer to lower right on screen).

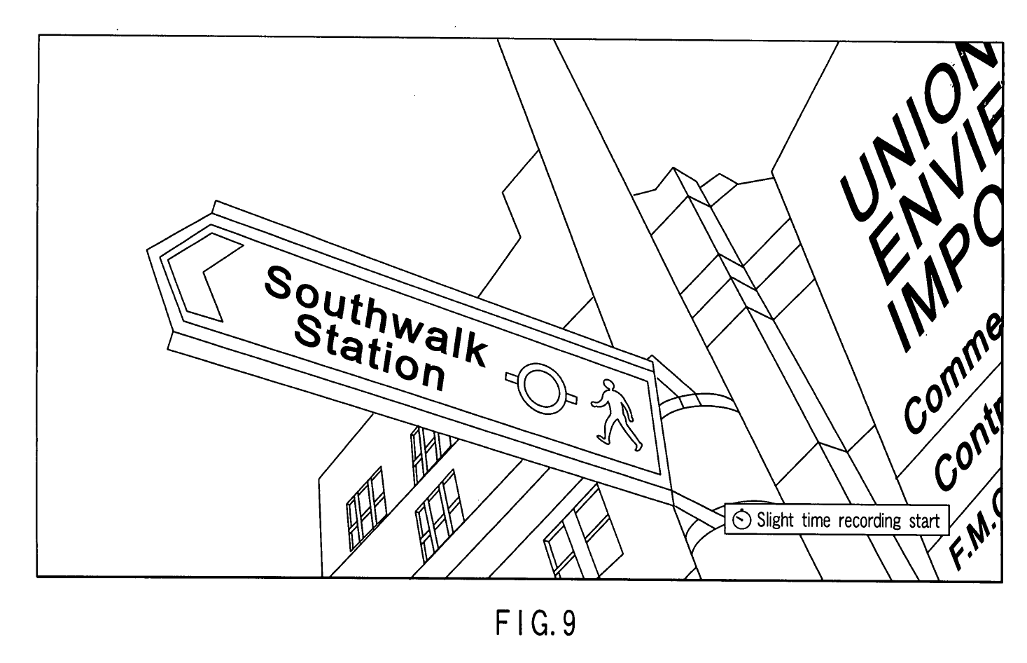

Further next, the screen shifts to a state shown in FIG. 9. Here, a comment of “Slight-time recording start” appears on the screen in FIG. 9 (refer to lower right on screen). The viewer looks the comment of “Slight-time recording start” then can recognize the fact that the slight-time recording has started.

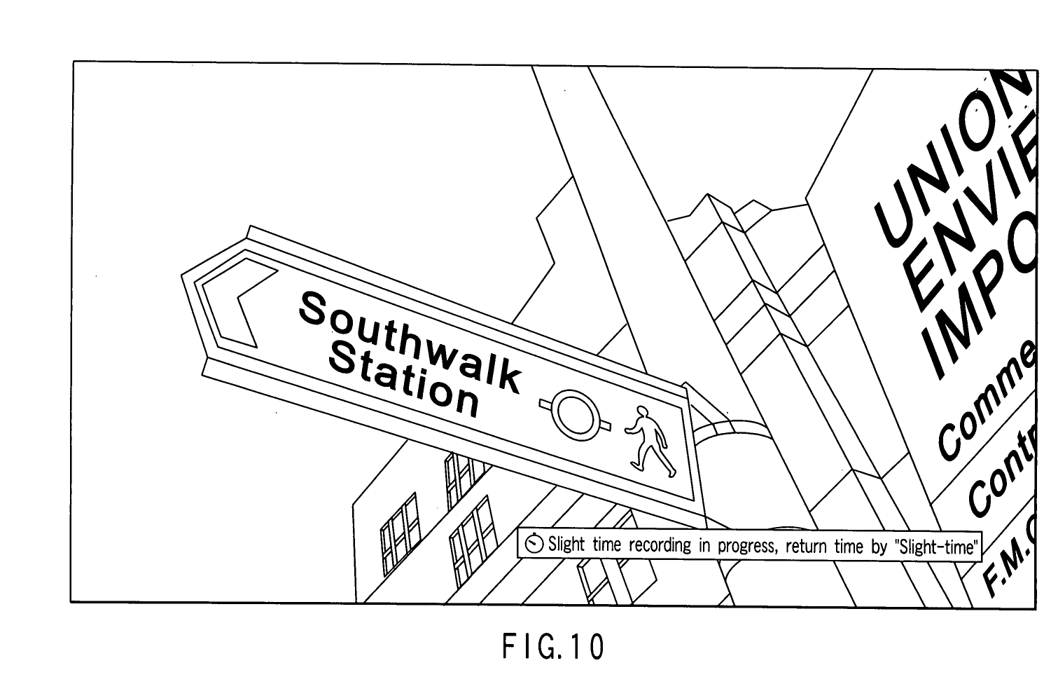

The screen sifts from the state shown in FIG. 9 to a state shown in FIG. 10. Here, a comment of “Slight-time recording in progress, return back time by ‘Slight-time’ key” (refer to lower right on screen). The sift to this screen means that a certain amount of recorded information is stored on the recording medium and also means that the broadcast receiver 11 becomes possible to perform the revolving reproduction.

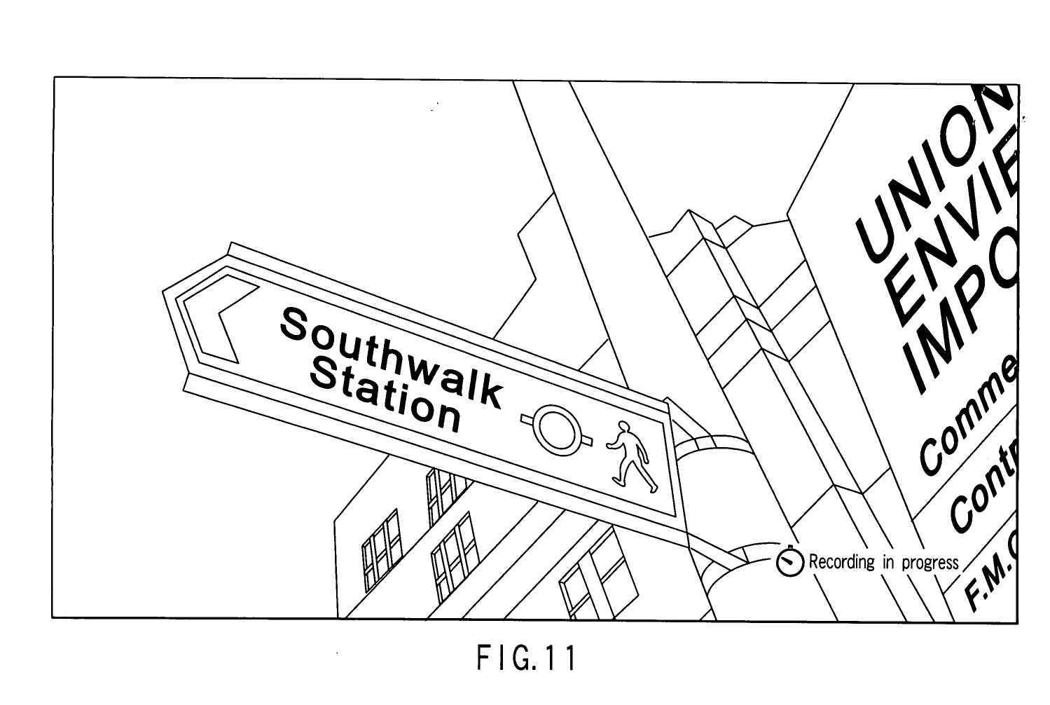

FIG. 11 shows a screen showing the continuation of the temporary storing. At this time, the screen displays a comment of “Recording in progress” (refer to lower right on screen). This comment allows the viewer to easily confirm whether or not the slight-time recording is in execution when the viewer returns back to the place where the broadcast receiver 11 is placed.

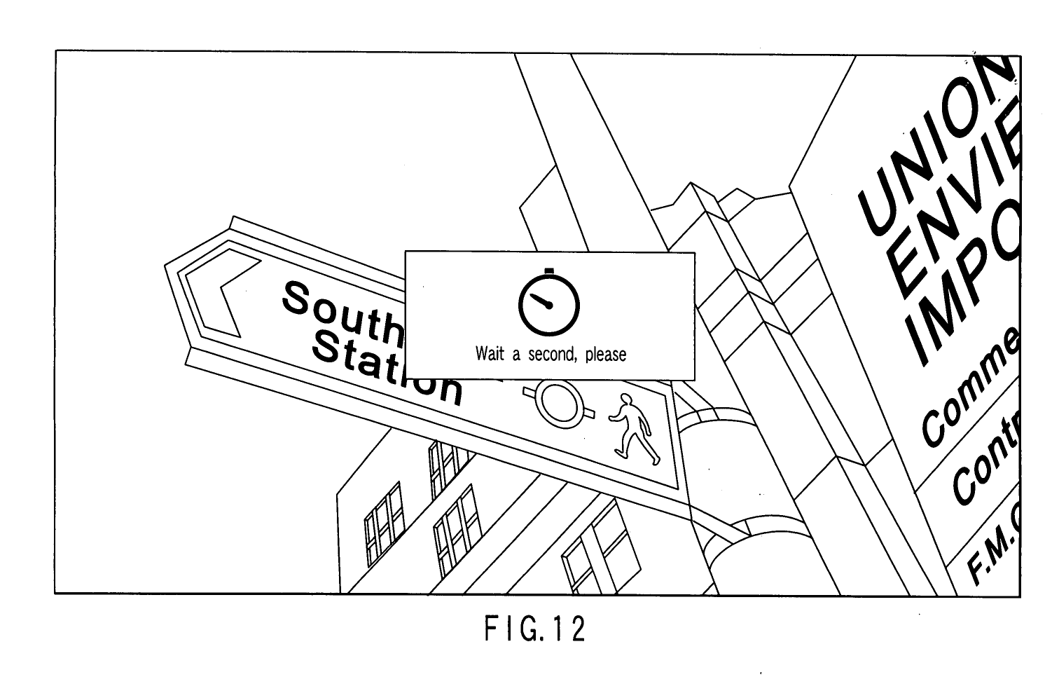

FIG. 12 shows an example of a screen which appears when the user returns back to the place where the broadcast receiver 11 is placed and presses the slight-time key 17q. At this moment, the broadcast receiver 11 starts to prepare to give back a reproduction starting position to a position from which the temporary storing has started, while still keeping on the continuation of the slight-time recording. That is to say, the broadcast receiver 11 shifts to the preparation of the revolving reproduction. At this moment, the screen displays a comment of “Wait a second, please” and also displays an illustration indicating a model of a hand of a clock (refer to center of screen). The hand of the clock then rotates counterclockwise and gives an impression to the viewer as if time went back.

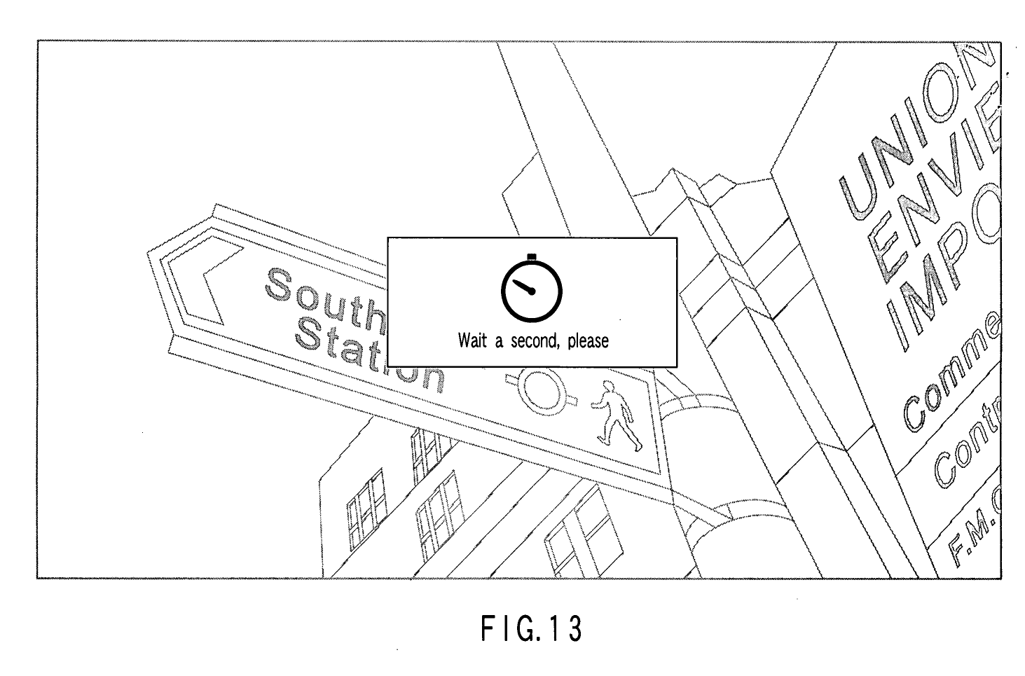

FIG. 13 shows an aspect that time has passed with the state shown in FIG. 12 and the color image has changed into the monochrome image. The aspect further changes into a muted state with lowering a sound volume gradually.

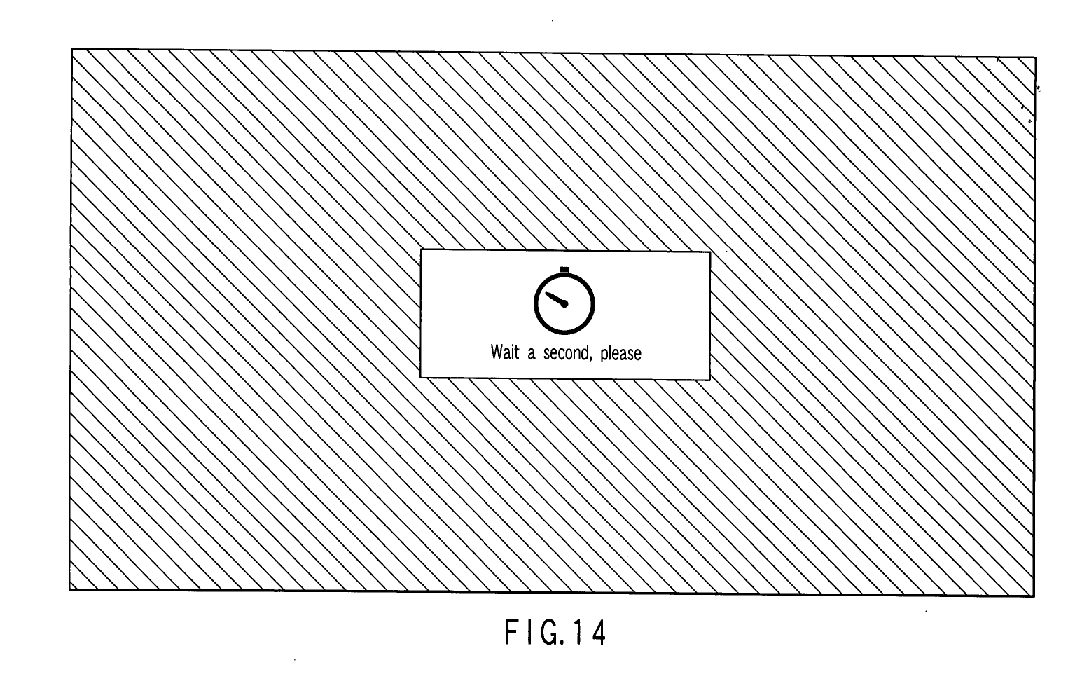

FIG. 14 shows an aspect that the state in FIG. 13 further proceeds and the screen becomes completely dark. With such a display performance, the viewer can easily recognize the start of the reproduction of the slight-time recorded content, through the display on the screen.

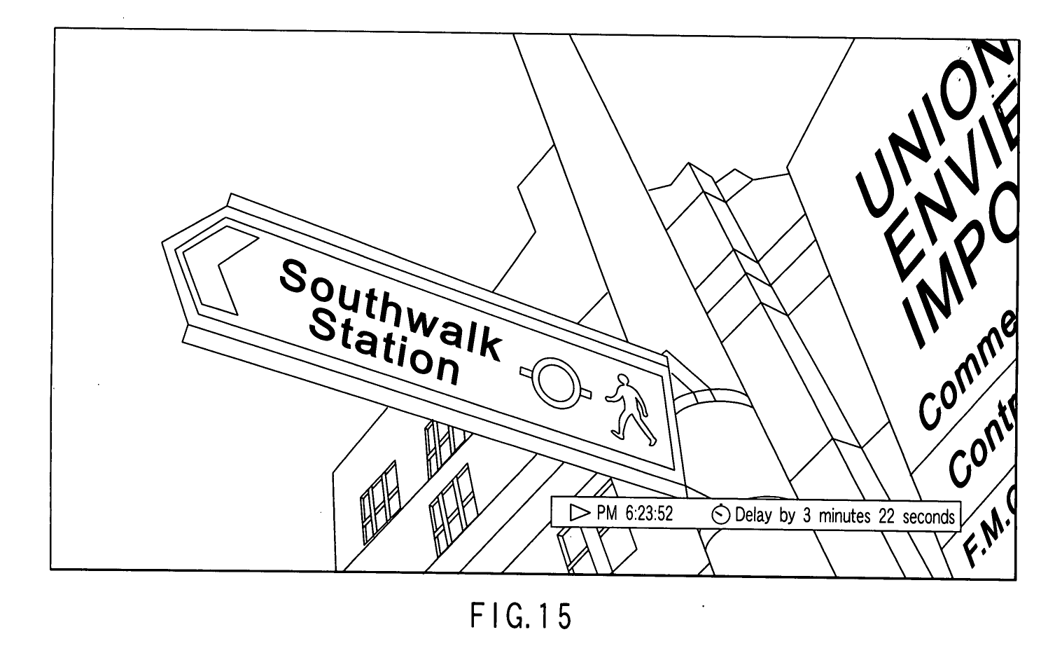

FIG. 15 shows the aspect that the slight-time recorded video has brought into the revolving reproduction state. The revolving reproduction means a reproduction of an already recorded content while recording a video being on the air in real time. On this screen for the revolving reproduction, a time difference between time on a reproduction screen (example in FIG. 14: 6:23:52) and actual time (example in FIG. 14: 3 minutes and 22 seconds delay) is displayed (refer to lower right in FIG. 14). Accordingly, the viewer can recognize the time difference between the image being on the air and the image now in revolving reproduction. The user may press the slight-(time)-skip key 17r again or decide any specific key to be pressed.

In the state in FIG. 15, when operating the slight-skip key 17r, the viewer can skip a reproduction position. The viewer may skip, for example, a video in a commercial message or a scene of a video in which the viewer is not interested, by operating the slight-skip key 17r. When the user catches up on the screen of the program going on the air by operating the slight-time skip key, the temporary storing processing (loop recording processing) is terminated.

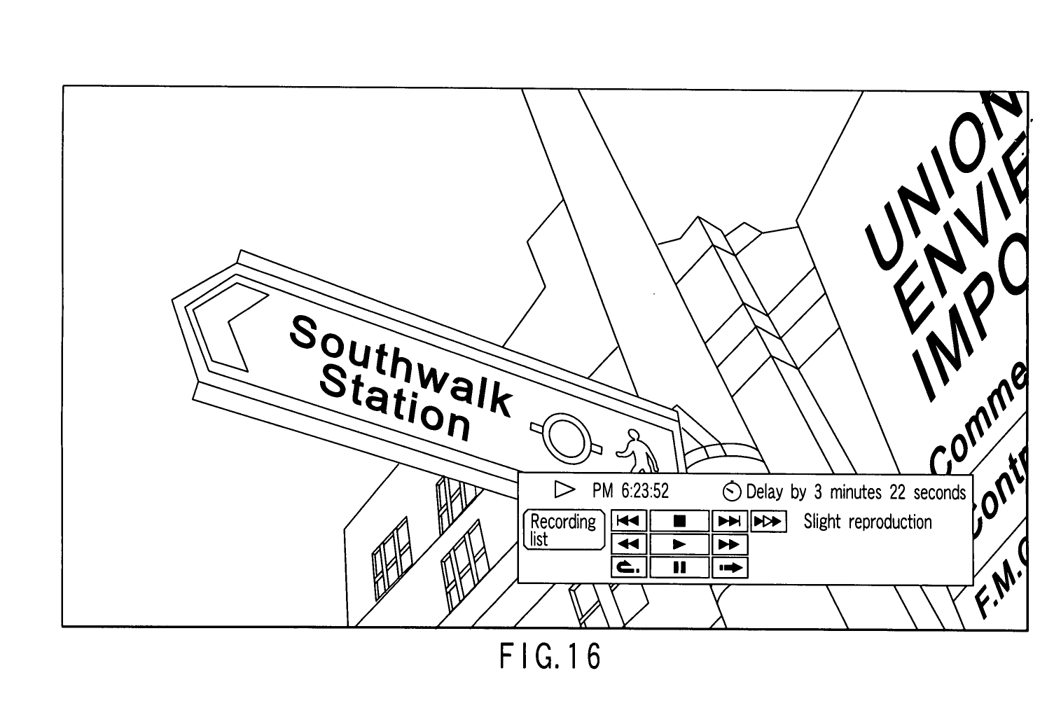

FIG. 16 shows an example of a display of an operation panel on a screen (refer to lower right on screen). This screen is displayed, for example, at an operation of a specific key (for example, the forgoing slight-skip key 17r) or at a touch of the channel up and down key 17n. Thereby, when selecting a functional mark on the operation panel by the cursor key 17f and pressing the determination key 17g, the user can execute pause, fast-forward reproduction, reverse reproduction, etc.

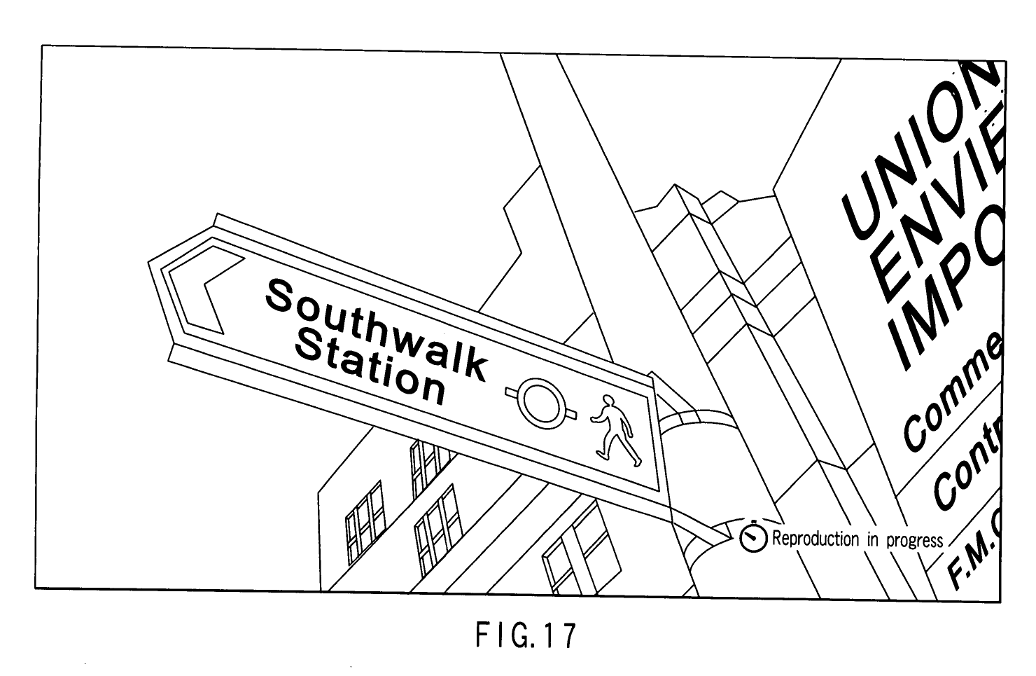

FIG. 17 shows a screen during revolving reproduction of a temporarily stored and recorded content. At this time, a clock mark and also a comment of “Reproduction in progress” are displayed so that the user can catch the aspect of the revolving reproduction (refer to lower right on screen).

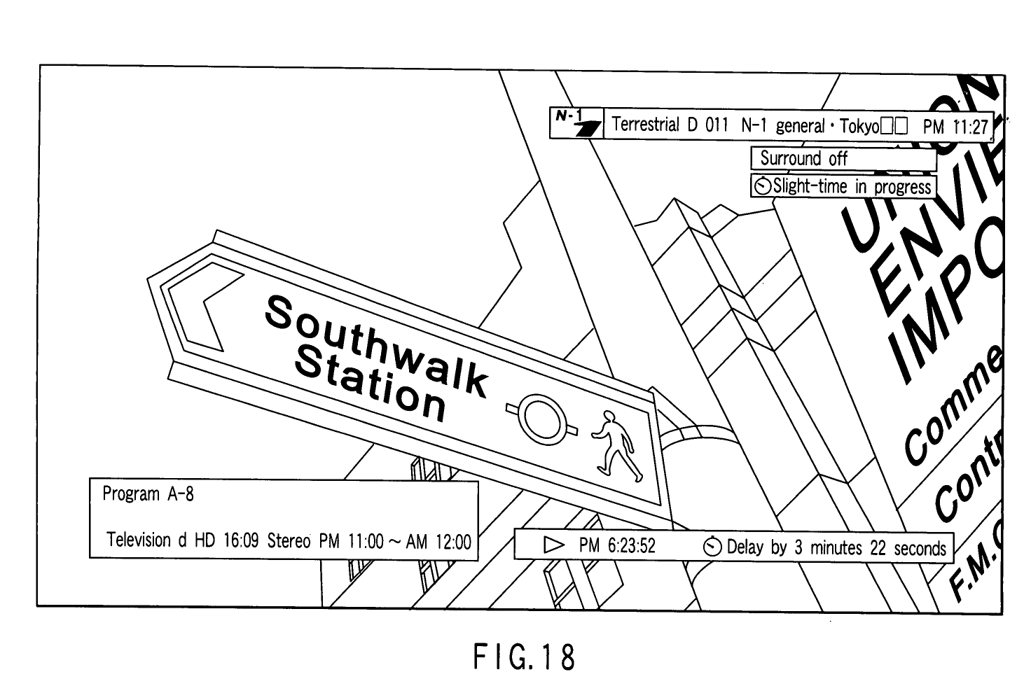

FIG. 18 shows an example of another screen during revolving reproduction of the temporary stored/recorded content. This example shows one aspect in which the viewer has selected a channel during the revolving reproduction. When the channel is selected, the kind and the channel of the selected broadcast program are displayed and also its screen display is displayed. And the fact that the revolving reproduction of the slight-time recording is in progress is also displayed in a comment so as to be recognized by the viewer (refer to upper right on screen). The lower left on the screen may displays information on a current broadcast-program name and a broadcast time-band.

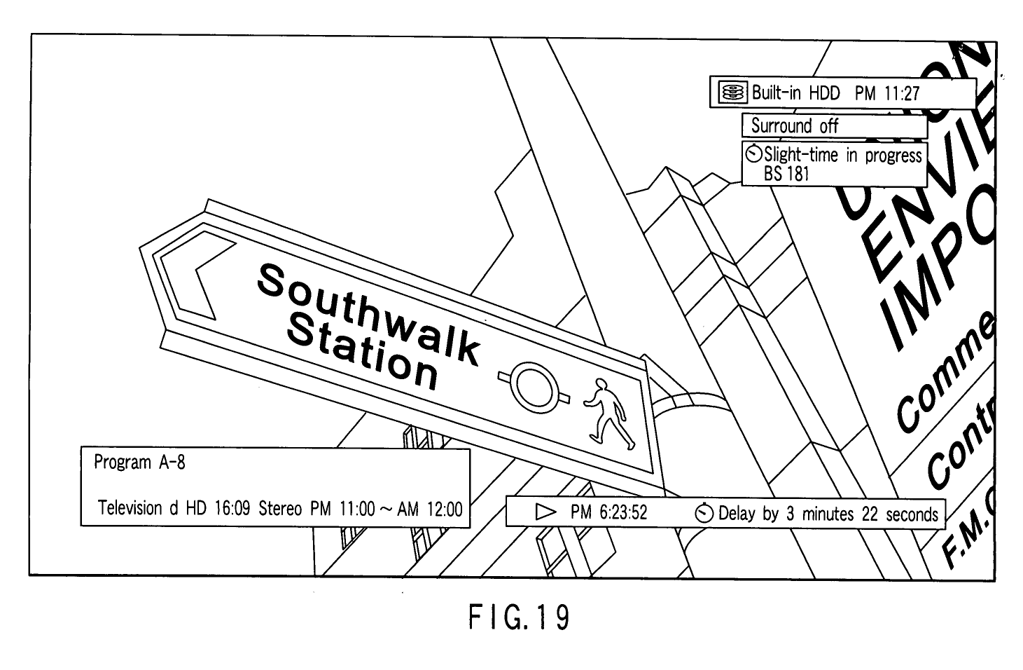

FIG. 19 shows an example of other screen for use in the event that the viewer is interested in other channels being on the air during the revolving reproduction of the slight-time recorded video. When performing a selection operation during the revolving reproduction, the viewer can switch over to a reproduction screen of the selected broadcast channel. At this moment, the comment of “Slight-time in progress” is displayed so as to make the slight-time recording, namely, the temporary storing operation is in progress be recognized easily, and it is displayed that which recording medium has been proceeding the temporary storing processing. The example in FIG. 19 shows that the slight-time recorded video is temporarily stored on the built-in HDD. And it is displayed that the kind of broadcast and channel number of the broadcast program with the slight-time recording set therefore are, for example, BS and 181.

Accordingly, the broadcast receiver 11 may also view the broadcast going on the air by selecting the channel even in the middle of the revolving reproduction of the slight-time recorded program.

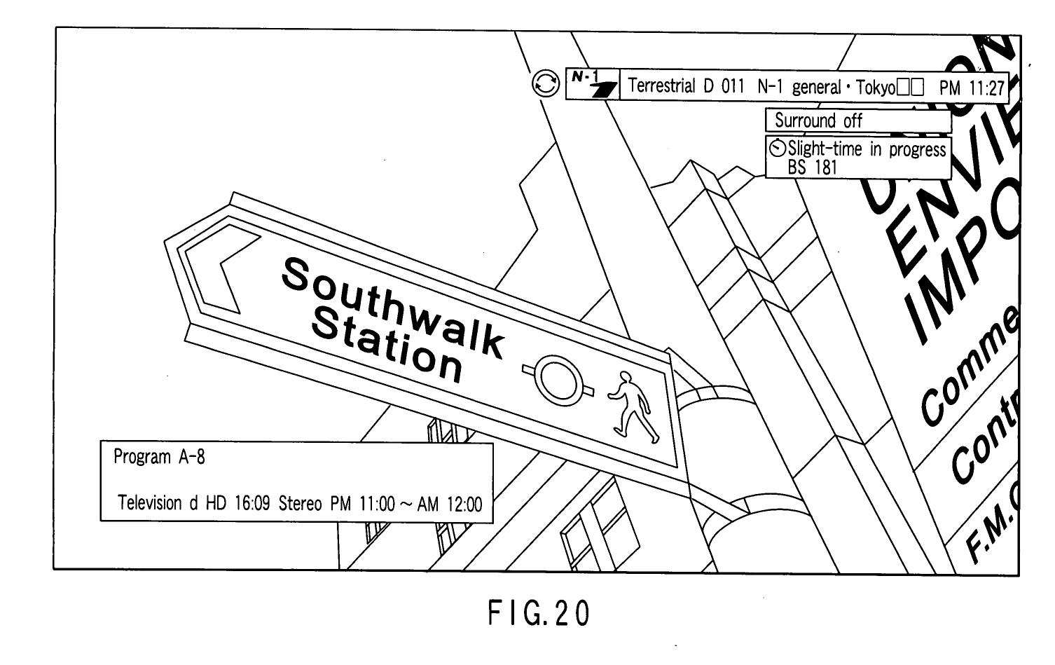

FIG. 20 shows a screen for use in the case that the viewer wants to confirm a screen of a channel different from a broadcast and a channel in the slight-time recording immediately after the start of the slight-time recording. This screen can be obtained by operating the channel up down key 17n for channel selection after the slight-time key 17q is pressed. In this case, since the channel selection has performed immediately after the start of the slight-time recording, the screen does not display a delay time related to the revolving reproduction. The screen showing the selected broadcast and the kind and channel thereof are displayed (the screen of the example in FIG. 20 displays the 011 channel of a terrestrial digital broadcast). In contrast, the screen displays that the kind and channel of the broadcast with the slight-time recording set thereto are, for example, BS and 181 so that the viewer can recognize that the slight-time recording has already started.

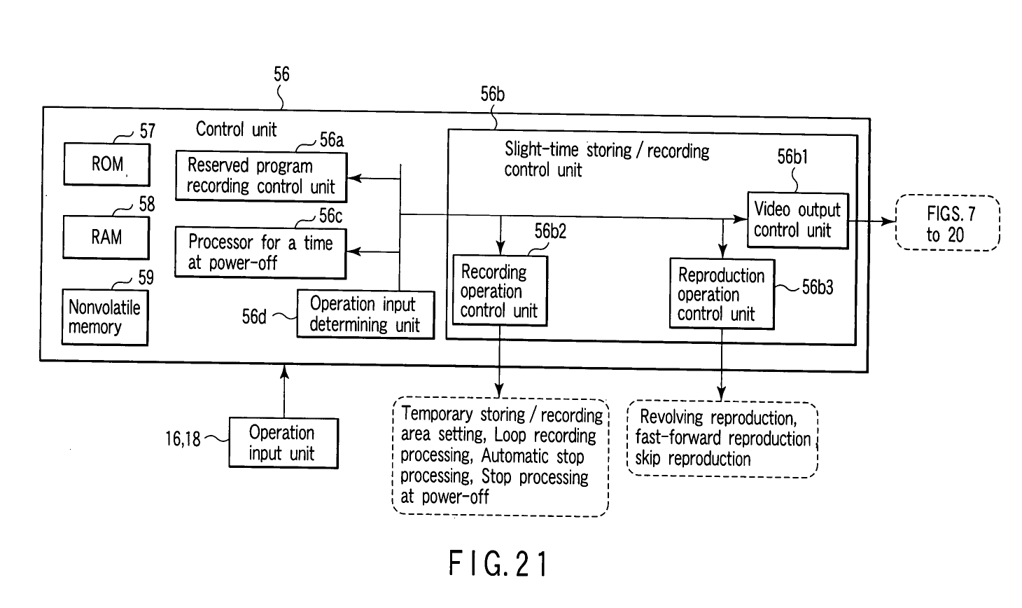

FIG. 21 shows the block diagram extracting the featured parts regarding the present invention. The control unit 56 includes the reserved program recording control unit 56a and the temporary storing control unit 56b as a main recording control unit to achieve recording. The reserved program recording control unit 56a is a control unit to automatically achieve recording reserved programs by referring to recording reservation information prepared by using such the electronic program table shown in FIG. 6. On the other hand, the temporary storing control unit 56b is a control unit to establish the temporary storing of the program being on the air by operating the slight-time key 17q.

The temporary storing control unit 56b has a video output control unit 56b1 as one of further classified function blocks. The video output control unit 56b1 control, as described with reference to the screens in FIG. 7 to FIG. 20, the contents on the screens in response to the operation states and operation situations of the broadcast receiver 11 so as to allow the user to easily recognize the current operation states thereof. A recording operation control unit 56b2 is a control unit to achieve the temporary storing when the slight-time key 17q is pressed. A reproduction operation control unit 56b3 is a control unit to realize the revolving reproduction, fast-forward reproduction or skip reproduction in the case of reproduction of the temporarily recorded contents.

The control unit 56 has an operation input determining unit 56d. It is natural that the operation of the temporary storing control unit 56b is decided in response to the determination result from the operation input determining unit 56d. The control unit 56 further has the countermeasure processor 56c for a time at power-off. We will go into details of the operation of the countermeasure processor 56c later.

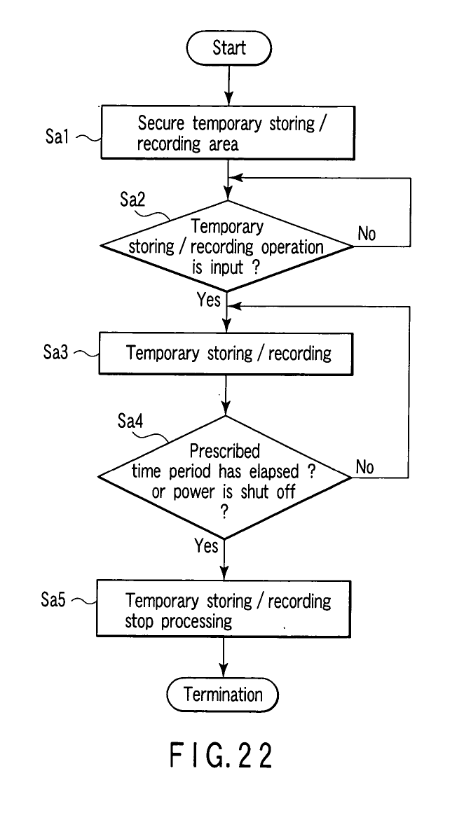

FIG. 22 shows an exemplary flowchart of operations and functions on the basis of the control by the temporary storing control unit 56b. The temporary storing area is secured (step Sa1). The AV-HDD 41 or the like secures the temporary storing area therein. The timing of the secure of the temporary storing area may be secured at the time of pressing of the slight-time key 17q or before the pressing thereof (step Sa1). Next, the control unit 56 determines whether or not the temporary storing operation has been input (step Sa2), and if the temporary storing operation has been performed, then the control unit 56 makes a shift to a temporary storing operation (step Sa3). Here, the broadcast receiver 11 records a program one after another from the top of the temporary storing area then overwrite-records from the top thereof after the temporary storing area is filled the recorded program. That is, the loop recording is performed. During the temporary storing, the control unit 56 determines whether or not a prescribed time period has elapsed or power has been shut off (step Sa4). If the prescribed time period has elapsed or the power has been shut off, the control unit 56 stops the position storing (step Sa5).

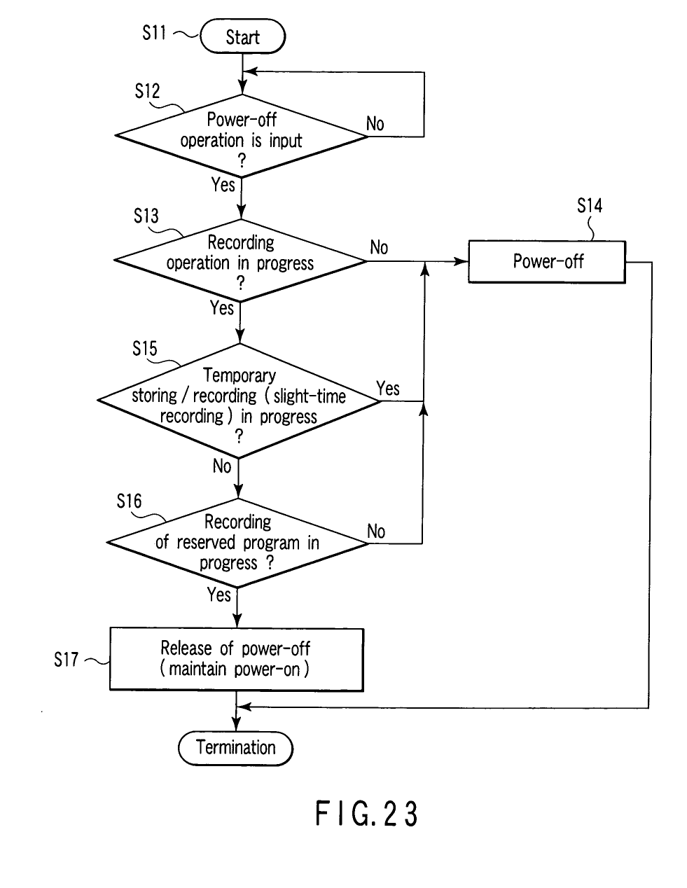

FIG. 23 is the exemplary flowchart showing the operation of the countermeasure processor 56c, by which it is determined whether power-off operation has been conducted or not (steps S11 and S12). If the power-off operation has been done, the countermeasure processor 56c determines whether or not the recording is now in progress (step S13). If the recording is not in progress, the countermeasure processor 56c shuts off the power (step S14) then terminates the processing of this flowchart.

If the recording is now in progress, the countermeasure processor 56c determines whether the temporary storing (slight-time recording) is in progress or not (step S15). If the broadcast receiver 11 is now in the temporary storing operation, the broadcast receiver 11 recognizes that an object of the temporary storing operation has achieved then the power is shut off in accordance with the operation input. Otherwise stated, the countermeasure processor 56c determines whether the reserved program is in progress or not (step S16). If the reserved program recording is not in progress, the countermeasure processor 56c shuts off the power, but otherwise stated, the countermeasure processor 56c releases a power-off command to maintain power-on (step S17) then terminates the processing in this flowchart.

A mentioned above, the broadcast receiver 11 can secure the temporary storing area on the recording medium in advance. And when the temporary storing operation is conducted, the broadcast receiver 11 records the program one after another from the top of the temporary storing area. When the temporary storing area has been filled with the recorded program, the broadcast receiver 11 performs overwrite-recording from the top of the area. That is, the loop recording is processed. Then, when the prescribed time period has elapsed after the recording is started by the temporary storing operation, the broadcast receiver 11 automatically stops the temporary storing operation. Therefore, even if the viewer forgets to release the loop recording operation, the broadcast receiver 11 can prevent the permanent recording continuation to suppress a sudden deterioration in the recording medium. In addition, the recording contents may be certainly recorded by prescribed amount (for prescribed time).

When the power-off operation is input, the broadcast receiver 11 determines whether it is in the state of the temporary storing operation or in the state of the reserved program recording operation. The determination result resulted in the state of the temporary storing operation may make the power shut off, and otherwise stated, may maintain the power-on unchanged. Accordingly, a recording failure of the reserved program may be avoided.

Furthermore, when the temporary storing operation is conducted, the motion image is maintained in a background on the screen then the comments indicating each stage of the preparation start of the temporary storing, the preparation in progress, the recording start and the recording in progress, as each mentioned in FIG. 7 to FIG. 20. Thereby, the user can confirm the fact that the temporary storing is in progress through the comment on the screen. The screen is a response to the operation by the user, so that the user can feels a sense of reassurance.

In the state of the temporary storing operation, the reproduction operation starts the revolving reproduction of the part of the recorded program. When the reproduction position has caught up the slight-time recording position by the fast-forward reproduction or the skip reproduction, the broadcast receiver switches over the reproduction screen to the screen of the program being on the air.

In the state of the temporary storing operation, the reproduction operation shifts the screen of the motion image from a color image to a monochrome image gradually and starts the revolving reproduction of the recorded part after deleting the motion image once. Accordingly, the user can easily recognize that the broadcast receiver 11 has shifted to the revolving reproduction.

And in the state of the temporary storing operation, when the reproduction operation is conducted, the broadcast receiver 11 produces a screen display the time information on the reproduction position and the time difference information between the recording position and the reproduction position. The broadcast receiver 11 therefore can recognize the situation of the revolving reproduction and make the recognition be a determination material to determine whether or not the broadcast receiver 11 performs the fast-forward reproduction or the skip reproduction.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A broadcast receiver, which has a control unit to integrally control operations, a receiving unit to receive broadcast signals on the basis of control of the control unit and a demodulating/signal processing unit to demodulate and signal process the received signals to convert them into display signals and means for storing the display signals on a recording medium in response to an operation input, comprising:
recording means for recording the display signals one after another on the recoding medium when a temporary storing operation is input; and
means for automatically stopping the temporary storing operation when a prescribed time period has elapsed from a recording start by the temporary storing operation.

2. The broadcast receiver according to claim 1, further comprising:
means for securing a temporary storing area on the recording medium in advance, wherein
the recording means overwrite-records the display signals from the top of the storing area when the storing area is filled with the display signals.

3. The broadcast receiver according to claim 1, further comprising:
means for determining whether the broadcast receiver is in the temporary storing operation state or in a reserved program recording operation state; and
means for shutting off power when the determination result results in the temporary storing operation state and for maintaining power-on unchanged when the determination result results in the reserved program recording operation state.

4. The broadcast receiver according to claim 1, further comprising a video output control unit, wherein the video output control unit maintains a motion image in a background and displays comments indicating states of a preparation start of temporary storing, a preparation in progress, a recording start and recording in progress, on a screen, when the temporary storing operation is input.

5. The broadcast receiver according to claim 1, further comprising a reproduction operation control unit, wherein
the reproduction control unit starts revolving reproduction of a recorded part when an reproduction operation is input and switches over a reproduction screen to a screen of a program being on the air when a reproduction position has caught up a recording position by a fast-forward reproduction or a skip reproduction in the temporary storing operation state.

6. The broadcast receiver according to claim 1, further comprising a video output control unit and a reproduction operation control unit, wherein
the video output control unit and the reproduction operation control unit make a shift of a screen of a motion image from a color image to a monochrome image gradually when an reproduction operation is input and start a revolving reproduction of a recorded part after deleting the motion image in the temporary storing operation state.

7. The broadcast receiver according to claim 1, further comprising a video output control unit, wherein
the video output control unit produces a screen display of time information on reproduction position and time difference information between recording position and the reproduction position when reproduction operation is input in the temporary storing operation state.

8. A broadcast receiving method for having a control unit to integrally control operations, receiving broadcast signals by a receiving unit on the basis of control by the control unit, demodulating and signal processing the received signals to convert them into display signals by a demodulating and signal processing unit and storing the display signals on a recording medium in response to an operation input, the method further comprising:
recording the display signals one after another on the recording medium when a temporary storing operation is input; and
automatically stopping a temporary storing operation when a prescribed time period has elapsed after a recording start by the temporary storing operation.

9. The broadcast receiving method according to claim 8, further comprising:
securing a temporary storing area on the recording medium; wherein
the recording includes overwrite-recording the display signals from the top of the storing area when the storing is filled with the display signals.

10. The broadcast receiving method according to claim 8, further comprising:
determining whether being in the temporary storing operation state or being in a reserved program recording operation state when a power-off operation is input; and
shutting off power when the determination result results in the temporary storing operation state and maintaining power-on unchanged when the determination result results in the reserved program recording operation state.

11. The broadcast receiving method according to claim 8, further comprising:
maintaining a motion image in a background; and
displaying comments indicating stages of a preparation start of temporary storing, a preparation in progress, a recording start and a recording in progress, on a screen, when the temporary storing operation is input.

12. The broadcast receiving method according to claim 8, further comprising:
starting a revolving reproduction of a recorded part when a reproduction operation is input; and
switching over a reproduction screen to a screen of a program being on the air when a reproduction position has caught up a recording position by a fast-forwarding reproduction or a skip reproduction, in the temporary storing operation state.

13. The broadcast receiving method according to claim 8, further comprising:
shifting a screen of a motion image from a color image to a monochrome image when a reproduction operation is input; and
starting a revolving reproduction of a recorded part after deleting the motion image once, in the temporary storing operation state.

14. The broadcast receiving method according to claim 8, further comprising:
producing a screen display of time information on a reproduction position and time difference information between a recording position and the reproduction position when reproduction operation is input, in the temporary storing operation state.
